(19) United States
(12) Patent Application Publication
(10) Pub. No.: US 2004/0017904 A1
(43) Pub. Date: Jan. 29, 2004

(54) System and method for validating calls within a telecommunications network

(76) Inventors: Damon Williams, Austin, TX (US); Daniel Solano, Austin, TX (US); Dan Bereczki, Austin, TX (US); Russ Bierschbach, Cedar Park, TX (US)

Correspondence Address: Erik B. Cherdak & Associates, LLC, Suite 906, 11300 Rockville Pike, Rockville, MD, 20852, US

(21) Appl. No.: 10/199,093

(22) Filed: Jul. 22, 2002

(51) Int. Cl. H04M 11/00; H04M 15/00

(52) U.S. Cl. 379/114.15; 379/114.01; 379/114.19; 379/91.01

(57) ABSTRACT

System and method for validating a call within a telecommunications network that is vendor-independent. The system and method include a messaging facility, a validation database, and a validation facility. The messaging facility is connected to the telecommunications network, and configured to message to and receive messages from a telecommunication device (e.g., router, IRVU, etc.) related to the call being placed within the telecommunications network and to receive a validation request related to the call from said telecommunications device, the validation request being in a first format. The validation database is configured to maintain data relating to validating authorities (e.g., CYBERCASH, CYBERSOURCE, etc.) and the validating authorities' messaging format requirements (e.g., request content, protocol, format, etc.). The validation facility is coupled to the messaging facility and to the validation database, and is configured to receive a validation request from the messaging facility, to identify a validating authority related to the request, to access the validation database to convert the request from the first format to the related validating authority's messaging format as a second format based on data stored in the validation database corresponding to the related validating authority, to contact the related validating authority to request validation from the related validating authority in the second format, to receive a response from said related validating authority in the second format, to convert the response from the second format to the first format, and to send the response in the first format to the messaging device to be messaged to the telecommunications device in order to validate said call.

### BACKGROUND OF THE INVENTION

1. Field of the Invention

The present invention relates to systems and methods for validating charges in commerce, such as credit card purchases. More particularly, the present invention relates to systems and methods for validating charges for completing a call in a telecommunications network, such as a calling card call or third party call.

2. Description of the Related Art

Systems and methods for validating credit card charges are well known. Systems, such as card swipe machines coupled to validation networks, facilitate the purchasing of over the counter goods and services, such as at retail stores, etc. Tellers use these systems manually by entering a credit card number into a system, such as by swiping the card, and then, the system directly dials up a service (e.g., CYBERCASH) to perform the authorization of a purchase.

Billing and authorizing a call in the telecommunications industry is not as straightforward because calls are often processed and complete automatically by telecommunications such as Interactive Voice Response Units (IVRU). IVRUs typically are used to automatically respond to calls (e.g., calling card calls, etc.) such as by audibly prompting callers with pre-defined (digitally recorded) voice messages such as those used in call centers to route callers to particular response facilities or personnel.

The process of authorizing a call may also be automated. For example, referring now to prior art figure FIG. 1A, when a call is made, such as a calling card call, it may routed from the calling party CP through a central office 108 through a switch 106 to an IVRU 104 that handles the validation of the call. Communication and control between devices is performed over an Ethernet control loop with the assistance of an SCP processor 120. The IVRU 104 prompts the calling party CP for a calling card number, in order to complete the call. After the calling party CP enters their calling card number (e.g., via a touch tone phone), the IVRU 104 passes the information to an SDP 110 which can then authorize or deny (validate) the call. The SDP 110 accesses a calling card database 112 and queries on the calling card and validates the calling card (and pin). After the card is validated, the SDP 110 messages the IVRU 104 and tells it whether the call is authorized or denied. If the call is authorized, the IVRU 104 passes the call off to be routed and completed.

In this prior art system, database 112 must constantly be updated to reflect currently active and available calling cards. The problem with maintaining a validation database for calling cards is that they change rapidly and are sold by many vendors. Alternatively, a company that specializes in the validation of calling cards, such as a clearing authority for calling cards, could be accessed to validate a calling card number. This is reflected in prior art FIG. 1A by a dashed box CA1 around SDP processor 110 and database 112.

In the case of credit card calls, there are a few methods currently being used to validate calls with a caller's credit card. One method is to route a call to an operator who can validate a caller's credit card manually, much like a retailer does as already described above with regard to retail goods and services. Or, a call could be routed to an IVRU that is configured to handle credit card calls through a similar service. In the latter case, the IVRU is connected to a processor that passes the information off to a service, such as by a hard coded service, such as VERIFONE, to validate the caller's credit card.

There are several problems with the current art in respect to validating calls through clearing authorities. First, validation services provided by authorizing bodies utilize proprietary messaging formats. Therefore, current solutions provided are hard-coded and vendor specific. Consequently, telecommunications providers are limited to particular validation authorities based on the solution they choose and cannot quickly and easily change vendors. Second, the organizations that validate calling cards, third party calls, and credit cards are separate, and a single solution that allows all types of validation of calls in a telecommunications network does not exist. Third, automated calls utilize disparate telecommunications devices, which may not be able to communicate directly with validation authorities or understand responses from a validation authorities.

Thus, there exists a need to provide new and improved vendor-independent systems and methods for validating calls in a telecommunications network. Such systems must provide a single solution to validating and authorizing all ways that a call can be charged (e.g., calling card, third party calls, credit cards, etc.). Moreover, such systems must provide both an automated process for validating a call within a telecommunication network and a manual process that may be performed by a telecommunications provider, for example, an operator. To be viable, such systems and methods must be implemented without causing significant burdens to network infrastructures or undue increases in infrastructure costs.

### SUMMARY OF THE INVENTION

The present invention solves the aforementioned problems and provides new and improved systems and methods for validating calls within a telecommunications network. Such systems and methods are capable of validating all types calls independent of clearing authority vendors and allows a telecommunications provider to change clearing authorities vendors without modifying any systems.

The present invention solves the aforementioned problems and provides the above-stated benefits by providing new and improved systems and methods for facilitating vendor-independent validation of calls within a telecommunications network. These and other objects of the present invention are achieved by providing a system for automatically validating a call within a telecommunications network that is vendor-independent. The system includes a messaging facility, a validation database, and a validation facility. The messaging facility is connected to the telecommunications network, and configured to message to and receive messages from a telecommunication device (e.g., router, IRVU, etc.) related to the call being placed within the telecommunications network and to receive a validation request related to the call from said telecommunications device, the validation request being in a first format. The validation database is configured to maintain data relating to validating authorities (e.g., CYBERCASH, CYBERSOURCE, etc.) and the validating authorities' messaging format requirements (e.g., request content, protocol, format, etc.). The validation facility is coupled to the messaging facility and to the validation database, and is configured to receive a validation request from the messaging facility, to identify a validating authority related to the request, to access the validation database to convert the request from the first format to the related validating authority's messaging format as a second format based on data stored in the validation database corresponding to the related validating authority, to contact the related validating authority to request validation from the related validating authority in the second format, to receive a response from said related validating authority in the second format, to convert the response from the second format to the first format, and to send the response in the first format to the messaging device to be messaged to the telecommunications device in order to validate said call.

According to another embodiment of the present invention provide is a method for facilitating the validating a call within a telecommunications network that is vendor-independent. The method includes the steps of: receiving a validation request in a first format from a telecommunications device handling the call within the telecommunications network; determining a validating authority related to the validation request; converting the validation request from the first format to an acceptable format related to the validating authority; sending the converted validation request in the second format to the validating authority; receiving a response from the validating authority based on the validation request; converting the response to the first format; and messaging the telecommunications device the converted response to validate the call.

### BRIEF DESCRIPTION OF THE DRAWINGS FIGURES

The present invention is described in detail below with reference to the attached drawing figures, of which:

FIG. 1A is a block diagram of a prior art system for validating and completing a calling card call within a telecommunications network;

FIG. 1B is block diagram of a vendor-independent system for validating calls within a telecommunications network according to a preferred embodiment of the present invention;

FIG. 2 is a block diagram of a data processing system that may be used to facilitate systems and methods of validating a call within a telecommunications network according to a preferred embodiment of the present invention;

FIG. 3A is a class diagram of a java program that facilitates vendor-independent validation of a call within a telecommunications network according to a preferred embodiment of the present invention;

FIG. 3B is a screen shot of a user interface form that may facilitate the generation of a validation request according to a preferred embodiment of the present invention;

FIG. 3C shows table definitions for a database that may be used to facilitate the validation of calls in a telecommunications network according to a preferred embodiment of the present invention; and

FIGS. 4A and 4B are a flowchart of a method for facilitating vendor-independent validation of a call within a telecommunications network according to a preferred embodiment of the present invention.

### DETAILED DESCRIPTION OF THE PREFERRED EMBODIMENTS

The present invention is now discussed in detail with regard to the attached drawing figures which were briefly described above. Unless otherwise indicated, like parts and processes are referred to with like reference numerals.

For the purposes of the discussion that follows, the term validator is synonymous with the terms clearing authority or bureau and validation authority or bureau, and relates to organizations that provide validation of charges, such as credit card purchases, etc.

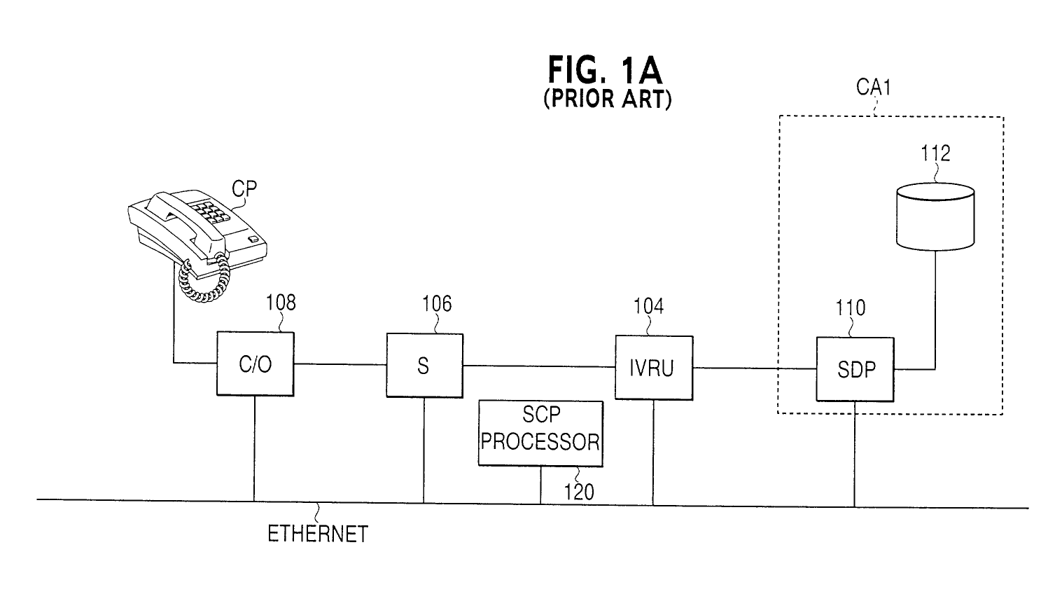

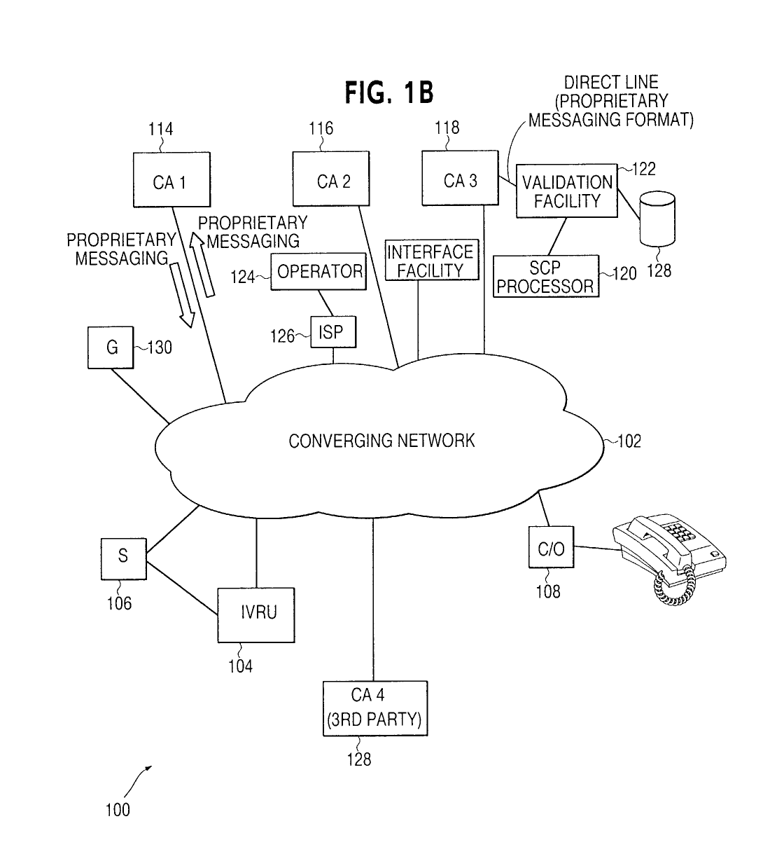

Referring now to FIG. 1B, depicted therein is a block diagram of a vendor-independent system for validating calls within a telecommunications network according to a preferred embodiment of the present invention. In particular, system 100 includes a merged telecommunications network 102 which may include at least portions of a global network, the publicly switched telephone network (PSTN), the Internet and WWW, etc. Moreover, system 100 may include switching systems, interactive voice response units, control facilities and database management facilities, interfacing facilities and a host of other telecommunications devices found in modern telecommunications networks and which may be accessed in merged telecommunications network 102 using a variety of modern communications protocols (X.25, TCP/IP, etc.) and device messaging schemes.

In system 100, a calling party such as calling party CP may utilize calling services through a central office 108 which is coupled to merged telecommunications network 102 to receive telecommunication services, such as placing a call, based upon communications functions provided by telecommunications devices. For example, a calling party CP may wish to place a voice call which will ultimately terminate at a called party (not shown) via central office 108. Moreover, a particular telecommunications service may include the operations of a router such as router (not shown) in the context of data based telecommunications services, voice response services, such as those provided by an IVRU 104, gateway services provided by gateway system 130, etc.

System 100 also includes a messaging facility 120, a validation facility 122, an interfacing facility IF, an Internet Service Provider (ISP) 126, a telecommunications operator 124, and a series of clearing authorities (CA) 114, 116, 118, and 128 that are owned and managed by different vendors.

When placing a voice call, such as a calling card call, calling party CP initiates a call that is routed through central office 108 to IVRU 104 or to an operator 124. In the case that the call is routed to IVRU 104, IVRU 104 audibly prompts the calling party CP with pre-defined (digitally recorded) voice messages that are used to route the call to particular response facilities or personnel (e.g., operator 124, etc.). Through these prompts and caller responses, IVRU 104 is configured to accept billing information, such as a billing number (i.e., third party call), a calling card or a credit, debit, or ATM card, etc. If the calling party CP does not have a touch tone phone, or wishes to speak to an operator, IVRU 104 may route the call to operator 124.

In the case that the calling party CP enters billing information for a call directly to the IVRU 104, such as via a calling party's touch tone phone, IVRU 104 messages messaging facility 120 a validation request in a generic format (messaging content and format may very from device to device depending on the vendor manufacturer, etc.), such as via TCP/IP, X.25, etc. messaging facility 120 passes the validation request to validation facility 122 for processing (validation and messaging facilities need not run on separate machines or computer arrangements, and may instead be separate program units in a software package, for example). For example, IVRU 104 could be configured to execute a java program to invoke validation facility via using Java RMI and pass the validation request to the validation facility 122.

Messaging facility 120 is any program, process or computer arrangement coupled to network 102 and configured to communicate (transfer data, message, etc.) with other devices over network 102 in at least one telecommunications or data protocol, such as TCP/IP, X.25, SS7, etc. For example, a computer arrangement properly configured and connected to the Internet is capable of transmitting data to another device over the Internet using TCP/IP, and a java program running on such an arrangement may also transmit or receive data via the Internet. Moreover, Java RMI could be used to invoke the procedures of a different Java program running on a different machine.

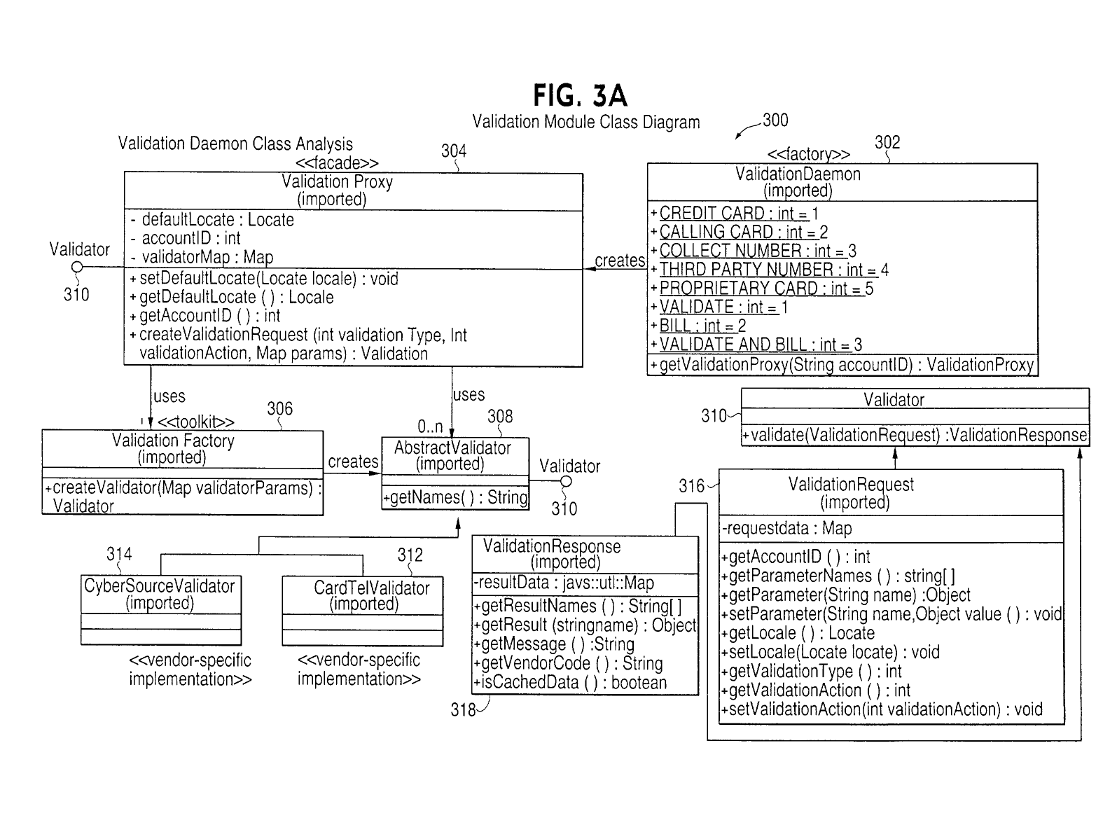

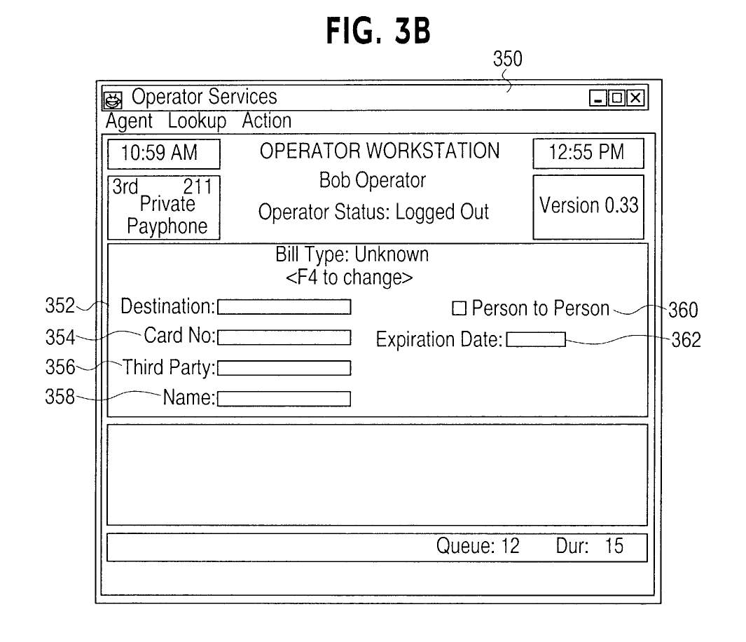

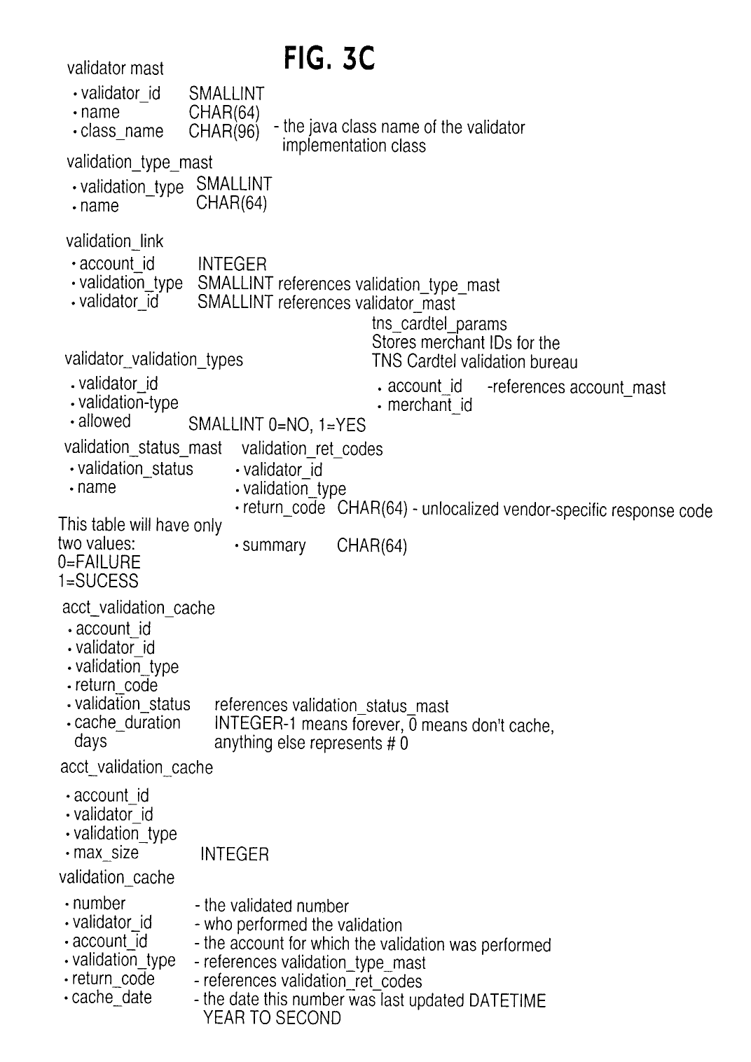

Validation facility 122 can be any program, process or computer arrangement that is configured to receive validation requests, to determine what type of payment to process (e.g., third party billing number, calling card, credit card, etc.), to select an appropriate clearing authority (CA1-CA4) to validate the charge. A class diagram of an exemplary java program that may perform some or all of functions of validation facility 122 is shown and described later in this patent document with reference to FIG. 3A. Validation facility 122 includes or is coupled to a database 128 that stores information related to each clearing authority and their particular requirements for validation requests.

Validation facility 122 is configured to access database 128 to determine the appropriate clearing authority based on the validation request (e.g., if a validation request including a calling card, a calling card validation bureau would be selected). Once an appropriate clearing authority is selected, validation facility 122 is configured to access database 128 and convert the validation request to the appropriate format based upon the data stored related to the clearing authority selected. Typically, each clearing authority requires different content (request codes, etc.) in a validation request and requires each request to be in a unique format (e.g., data format, data or messaging protocol, etc.). For example, TNS CARDTEL accepts requests sent over the X.25 protocol, formatted in a vendor-specific manner. An example validation request is

“C2C01654248136402549419412104515 26362210030549178001003054918339.”

An exemplary table structure for a validation database is shown and described with reference to FIG. 3C.

Once validation facility 122 generates a validation request in the proper format, it is configured to connect to the appropriate clearing authority (CA1-CA4), such as via a direct line (e.g., dialup service), via a modem, as shown connected to CA3 118, or via converging network 102, such as via the Internet and World Wide Web (e.g., using TCP/IP), and submit the converted request. The clearing authority solicited will validate (authorize or deny) the charge as defined by its normal course of business. For example, TNS CARDTEL is a clearing house used to validate credit cards. A calling party's CP credit card number is submitted to TNS CARDTEL in the format required by the same, such as the example above, and TNS CARDTEL, in turn, will respond with a proprietary code that can be mapped to Pass or Fail. A response to the request above may be

“C5C016542481364025465495120005432 10350010030549178001003054918339”

which is a good response that can be mapped to PASS.

Once validation facility 122 receives a message from the solicited clearing authority, it is configured to access database 128 to convert the message to a usable messaging format, such as Pass or Fail, such as in the same messaging format used by the requesting party (e.g., IVRU 104). Validation facility 122 passes the converted response to messaging facility 120, which is configured to message the telecommunications devices necessary to complete the call (i.e., complete the call to the called party upon a Pass response and deny the call to the calling party on a Fail response), such as IVRU 104, switch 106, routers (not shown), etc.

A system and method for messaging and controlling telecommunications devices within a telecommunications network are described in a co-owned, co-pending U.S. patent application, Ser. No. 09/414,668 entitled “SYSTEM AND METHOD FOR COMMUNICATING WITH AND CONTROLLING DISPARATE TELECOMMUNICATIONS DEVICES IN A TELECOMMUNICATIONS NETWORK,” filed on Oct. 7, 1999, which is incorporated herein by reference. Accordingly, the reader of this patent document should refer to the aforementioned co-owned, co-pending U.S. patent application for complete disclosure details related to the operations of present invention with regard to controlling disparate telecommunications devices, such as routers, etc.

As described above, calls may also be routed to the operator 124 (e.g., credit card calls, etc.) for handling. In this case, a calling party's CP call is routed by central office 108 or IVRU 104 to operator 124. Operator 124 accesses interface facility IF and receives a user interface form via converging network 102. An exemplary user interface form that is configured to facilitate the submission of a validation request according to a preferred embodiment of the present invention is shown and described with reference to FIG. 3B.

Referring now to FIG. 3B, shown therein is a screen shot of an operator workstation. In particular, form 350 has several fields to be entered that facilitate operator management of an initiated call. Destination 352 allows an operator to enter the destination number (i.e., the number of the called party); card number 354 allows the operator to enter the calling card or credit card, or ATM card number to be charged; third party 356 allows the operator to enter a third party number to be charged; name 358 allows an operator to enter the name of the caller, the name on the calling card, credit card, etc. or could be used to enter the name of the third party to be charged; person to person checkbox 360 allows an operator to indicate whether the call is “person to person;” expiration/pin # 362 allows an operator to enter the expiration date of a credit card or the pin number of a calling card (ATM card, etc.); and response window 364 returns the validation response.

Operator 124 submits a validation request via interface facility IF by obtaining and submitting the necessary billing information, which is delivered to messaging facility 120 (such as by committing the data to database 128, for example, or by invoking and passing the necessary data to validation facility 122 using Java RMI), which passes the request to validation facility 122. Validation facility 122 then handles the request as already described above with regard to a validation request from an IVRU. Validation facility 122 determines an appropriate clearing authority based on the information submitted on the user interface form. For example, a if a third party number is submitted in the request, a third party validation bureau will be selected from database 128. Next, validation facility 122 accesses database 128 and converts the validation request into the proper format based on the validation bureau selected and sends (e.g., via a direct line, Internet, messaging, etc.) the converted request to the appropriate clearing authority to validate the charge. As described above, a clearing authority will typically return a code or message, possibly in the same proprietary format, that may be converted to a Pass or Fail or some other usable format. Validation facility 122, once it receives a response from the clearing authority, converts the response and passes it to messaging facility 120. Messaging facility 120 is configured to access interface facility IF to send a message to operator 124 reporting the response (e.g., to response window 364) to complete the call, or may instead, automatically complete the call by messaging the response to the appropriate telecommunications devices (IVRU, etc.) as already described above. Upon the completion of the call, a message may also be sent to operator 124 reporting a successful validation of the call.

Validation database 128 can be any well known database engine, such as MICROSOFT SQLSERVER manufactured by MICROSOFT CORPORATION, and an exemplary database structure is shown and described in table form with reference to FIG. 3C below.

Operator 124 can be any network client, such as a PC arrangement connected to the Internet and WWW and running a web browser, and configured to access interface facility IF, to download and execute a user interface form served by server facility 102 to place a validation request and receive a validation message as described above.

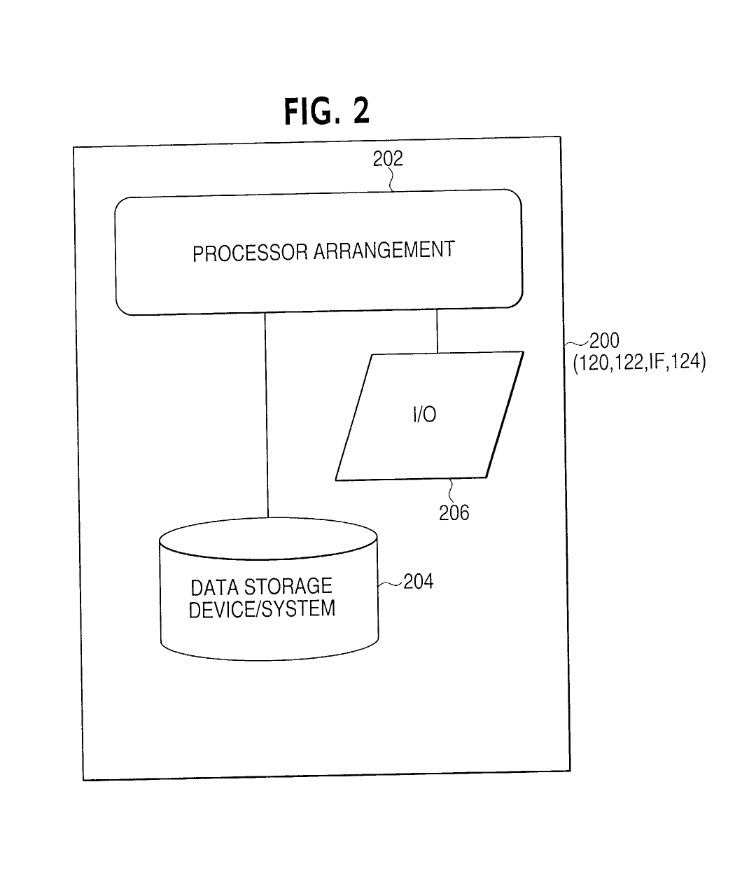

Referring now to FIG. 2, depicted therein is a block diagram of a computing system which may be used to implement client, server and database management facilities as well as telecommunication devices, as described above with regard to FIG. 1B in accordance with a preferred embodiment of the present invention. Moreover, the computing system shown in FIG. 2 may be configured to execute the interfaces and processes shown with reference to FIG. 1B, FIG. 3A, and FIG. 3B. In particular, FIG. 2 depicts a data processing system 200 which further includes a processor arrangement 202 including one or more processing elements, a data storage subsystem 204, an IO facility 206. The arrangement of these structures shown with data processing system 200 will be immediately understood by those skilled in the art.

Data processing system 200 is configured to store and to serve files (data files, user interface files, HTML documents, etc.). Data processing system 200 is further configured to execute processes such as processes used to facilitate validation facility 122, a web browser, user interface form 350, a database engine for validation database 128, and other necessary database and operating system processing.

Through IO facility 206, data processing system 200 is further configured to connect to telecommunications network 102, an electronic data network, such as the global network, the Internet or World Wide Web, and send and receive data, such as messages and other communications, via such networks, such as via protocols TCP/IP, SS7, X.25, etc.

Data storage subsystem 204 as shown within data processing system 200, can store all files necessary to facilitate the present invention, such as clearing authority data, codes, data supporting user interface forms, such as form 350, and other data used for the mapping and conversion of messages to facilitate the validation of a call or charge according to a preferred embodiment of the present invention.

Referring now to FIG. 3A, shown therein is a class diagram of a exemplary java program that may be used (launched, executed, etc.) to facilitate vendor-independent validation of calls in according to a preferred embodiment of the present invention. In particular, java program 300 includes java classes that convert requests and responses to appropriate formats for messaging to clearing authorities, telecommunications devices, operators, etc. Such classes include a validator 310 made up from validationrequest class 316 that handles requests and validationresponse class 318 that handles the response from the validation bureau. A validation daemon 302 accepts the validation request and creates a validation proxy 304. The validation proxy 304 then maps the validation parameters with validation factory 306 and abstract validator 308, which utilizes vendor specific classes such as CyberSourceValidator 314 and CardTelValidator 312. The program is configured to determine the clearing authority to which submit the request, convert the request to vendor specific format and content, and to receive a response from the clearing authority, convert the response to a useable format, and to send the response to the requesting party, such as operator 124 or IVRU 104. Java program 300 gets data from a database having the structure defined by the table structure shown and described below with reference to FIG. 3C.

Java program 300 may be modified to include vendor information for all clearing authorities, and the addition of database tables and classes to support the addition of new and unique clearing authority data will be readily understood by one having ordinary skill in the art. Although java is a well known language that is useful for various reasons, including scalability, etc., the invention is not intended to be limited to a java implementation and the use of other valuable programming languages or techniques may be used to implement the present invention.

Referring now to FIG. 3C, depicted therein are table definitions for a database that may be used to facilitate the validation of calls in a telecommunications network according to a preferred embodiment of the present invention. The tables shown therein support the storing and maintenance of data that may be used to convert validation requests and responses to useable formats, such as vendor specific formats, in order to validate a call.

In particular, a validator mast table is provided to store basic information on validators. Validation_type_mast defines the possible types of validation (i.e., credit card, calling card, collect, third party, etc.). Valiadation_link stores which validator is used by which account. This allows for a customer to use different validators for different types of validation. Validator_validation_types defines which validation types are supported by a specific validator. Validation_status_mast defines the general status responses that can be used for validation. Validation_ret_codes defines all the response codes possible for a given validator and validation type.

Caching tables can be provided so that the system may cache recently validated numbers so that subsequent validation requests on a repeated number can be handled internally. This can eliminate the costs of calling a validation bureau. Acct_validation_rules maps generic response codes to pass/fail response codes, and defines how long to cache validation data. Acct_validation_cache stores various parameters for caching. Validation_cache stores the results of validation queries.

Tables are needed to define validation parameters for specific validation bureaus (clearing authorities). For instance, CYBERSOURCE has a number of threshold parameters that determine the result of the validation request. Also, in general, each validation bureau will have account/merchant IDs of their own that will need to be used when making a requests. For example, tns_cardtel_params stores merchant identifiers (IDs) for the TNS CARDTEL validation bureau. Of course, a general validator_params table could be used to store parameters from all different validators in a key-value matching relationship. However, this method is inferior to using different tables for different validators. One reason is because it is less confusing when the data is easily separated out into multiple tables.

The design and structure of databases are well known, and the implementation of the present invention with the table structure above will be readily understood by one having ordinary skill in the art.

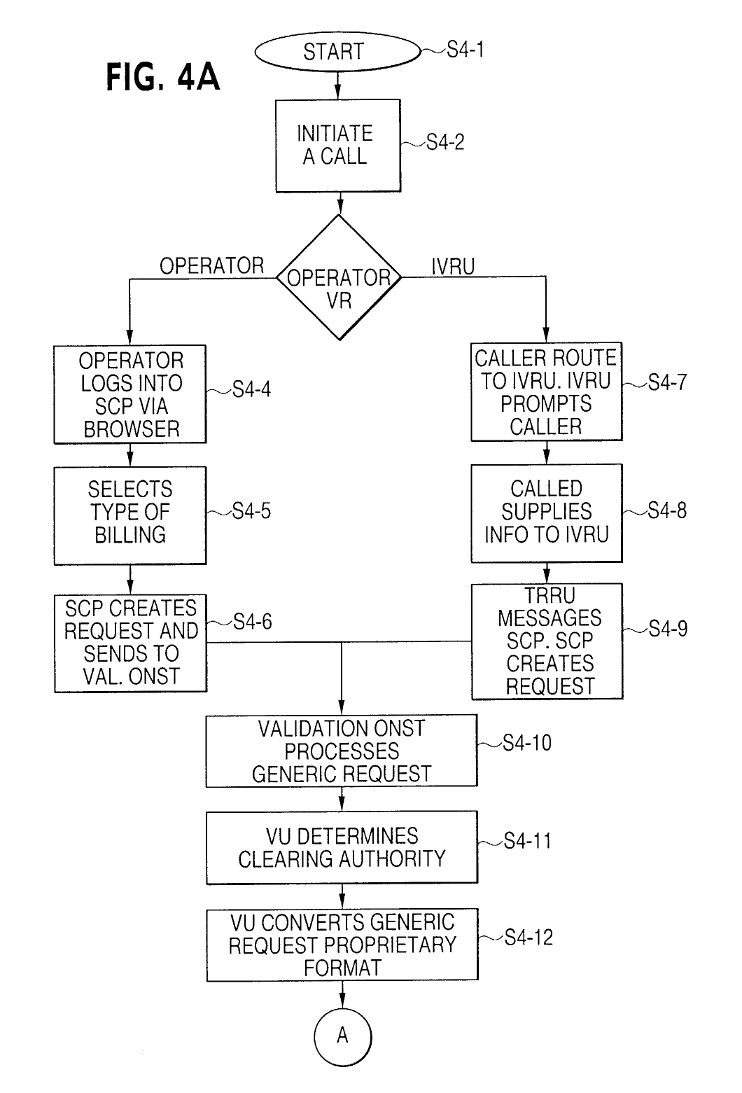

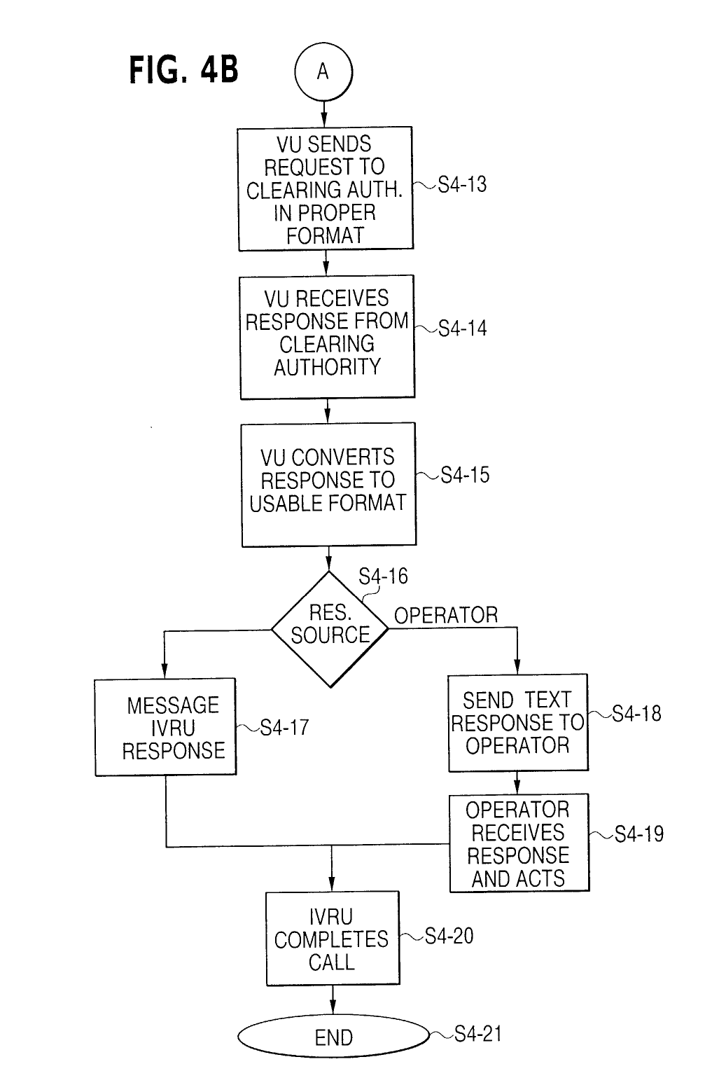

Referring now to FIG. 4, depicted therein is a flow chart of a method that facilitates vendor-independent validation of a call within a telecommunications network according to a preferred embodiment of the present invention. Operations starts at step S4-1 and immediately proceeds to step S4-2.

At step S4-2, a calling party initiates a call, such as a calling card call. The initiation of a call is performed as calls are normally initiated in a telecommunications network.

Next at step S4-3, the call is routed either to an operator or to an IVRU which handles the call. The routing of a call to an IVRU or operator will be readily understood by one having ordinary skill in the art. If the call is routed to an operator, then processing proceeds next to step S4-4. Otherwise if the call is routed to an IVRU for handling, processing proceed to step S4-7.

At step S4-4, the operator logs into a web site and receives a user interface form, such as form 350 shown and described with reference for FIG. 3B, via a web browser.

Next, at step S4-5, the operator selects the type of billing for the call. The operator may do this by interacting with the calling party and filling out the appropriate fields on the user interface form.

Next, at step S4-6, the user interface form is processed and a validation request is created. The information entered on the user interface form may be committed to a database or otherwise packaged and passed to a validation facility, such as validation facility 122 (e.g., a java applet or program) configured as already described above with reference to system 100. The user interface form and validation facility may be stored, served and executed on the same machine or one different machines communicating with one another, such as via TCP/IP over the Internet.

If the call is directed to an IVRU, processing proceeds to step S4-7. At step S4-7, an IVRU handles the call by voice prompting the caller for various information, such as billing information, destination number, etc. The handling of a call by an IVRU is well known and will be readily understood by one having ordinary skill in the art.

Next, at step S4-8, the calling party supplies the necessary information to the IVRU, such as via a touch tone phone. Then, at step S4-9, the IVRU generates a generic validation request to be sent to a validation facility, such as validation facility 122.

At step S4-10, the validation facility receives and processes a validation request submitted from an IVRU or an operator (i.e., user interface form). The passing of data from a one machine to another via an electronic data network or telecommunications network is well known, and one having ordinary skill in the art will readily understand the passing of data from an IVRU or user interface form to a validation facility, such as validation facility 122.

Next, at step S4-11, the validation facility determines the appropriate clearing authority to send the validation request. The selection of a clearing authority has already been described above with regard to system 100 and is incorporated here by reference.

Next, at step S4-12, the validation facility converts the generic request to the appropriate format accepted by the selecting clearing authority. The conversion of the validation request to the proper format is performed as already described above with regard to system 100. Processing next proceeds to A which continues on FIG. 4B.

Referring now to FIG. 4B, next at step S4-13, the validation unit sends the converted validation request to the appropriate clearing authority. The submission of a validation request to a clearing authority is performed as already described above with reference to system 100.

Next at step S4-14, the clearing authority responds to the validation request, and the response is received by the validation facility.

Next, at step S4-15, the validation unit converts the response into a usable format, such as the same format of the original generic request. The conversion of the response to a usable format is performed as already described above with regard to system 100.

Next at step S4-16, processing proceeds to step S4-17 in the case that an IVRU is the source of the original request, and processing proceeds to S4-18 in the case that an operator (user interface form) was the original source of the validation request.

Next at step S4-17, a message is sent to the IVRU containing the response. For example, a Pass or Fail may be messaged to the IVRU. The messaging of a response to the IVRU is already described above with reference to system 100. Processing proceeds from this step to step S4-20.

At step S4-18, a message is sent to the user interface form executed by the operator to send the original request. Such a message may be sent as already described above with reference to FIG. 3B.

At step S4-19, the operator acts on the response and completes the call appropriately.

At step S4-20, the IVRU receives the response and completes the call appropriately.

Processing stops at step S4-21.

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims. For example, the validation facility, interface facility, validation database and messaging facility are all shown as separate entities in system 100 as shown in FIG. 1B. However, the invention is not intended to be so limited. Each facility is performs a logical function, and the implementation of system 100 may be modified to provide all the functionality on one server computer, for example. The implementation and design of system 100 may be modified according to many design considerations and requirements, and the modification of system 100 as such will be readily understood by one having ordinary skill in the art.

For example, the method and system described above may be modified to handle additional requirements, such as system security (database, file system, etc.) or performance requirements.

What is claimed is:

1. A system for automatically validating a call within a telecommunications network that is vendor-independent, comprising:
a messaging facility connected to said telecommunications network, and configured to message to and receive messages from a telecommunication device related to said call within said telecommunications network and to receive a validation request related to said call from said telecommunications device, said validation request being in a first format;
a validation database configured to maintain data relating to validating authorities and said validating authorities' messaging formats; and
a validation facility coupled to said messaging facility and to said validation database, and configured to receive said validation request from said messaging facility, to identify a validating authority related to said request, to convert said request from said first format to said related validating authority's messaging format as a second format, to contact said related validating authority to request validation from said related validating authority in said second format, to receive a response from said related validating authority in said second format, to convert said response from said second format to said first format, and to send said response in said first format to said messaging device to be messaged to said telecommunications device in order to validate said call.

2. The system according to claim 1, wherein said telecommunications device is an Interactive Voice Response Unit.

3. The system according to claim 1, wherein said related validating authority is a credit card clearinghouse.

4. The system according to claim 1, wherein said related validating authority is a calling card clearinghouse.

5. The system according to claim 1, wherein said related validating authority is a third party call clearinghouse.

6. The system according to claim 1, wherein said first format is TCP/IP.

7. The system according to claim 1, wherein said validation database maps said validating authorities' messaging formats to a general messaging format.

8. The system according to claim 8, wherein said validation facility is a java program.

9. A system for validating a call within a telecommunications network that is vendor-independent, comprising:
a server system coupled to said telecommunications network via an electronic data network, said server system storing and serving at least one user interface form corresponding to said call, said server system configured to be accessed via said electronic data network to enable a user to receive and process said at least one user interface form to provide billing information related to said call and to generate and send a validation request via said electronic data network in a first format;
a client data processing system coupled to said server system via said electronic data network and configured to receive and process said at least one user interface form within a browser application;
a messaging facility connected to said telecommunications network, and configured to message to and receive messages from a telecommunication device related to said call within said telecommunications network and to receive a validation request related to said call from said telecommunications device, said validation request being in a second format;
a validation database configured to maintain data relating to validating authorities and said validating authorities' messaging formats; and
a validation facility coupled to said electronic data network, to said messaging facility, and to said validation database, and configured to receive said validation request, to identify a validating authority related to said request, to convert said request from said first or second format to said related validating authority's messaging format as a third format, to contact said related validating authority to request validation from said authority in said third format, to receive a response from said related validating authority in said third format, to convert said response from said third format to said first or second format, and to send said response in said second format to said messaging device to be messaged to said telecommunications device in order to validate said call.

10. The system according to claim 9, wherein said validation facility is further configured to send said response to said client processing system in said first format.

11. The system according to claim 9, wherein said telecommunications device is an Interactive Voice Response Unit.

12. The system according to claim 9, wherein said related validating authority is a credit card clearinghouse.

13. The system according to claim 9, wherein said related validating authority is a calling card clearinghouse.

14. The system according to claim 9, wherein said related validating authority is a third party call clearinghouse.

15. The system according to claim 9, wherein said second format is TCP/IP.

16. The system according to claim 9, wherein said validation database maps said validating authorities' messaging formats to a general messaging format.

17. The system according to claim 9, wherein said validation facility is a java program.

18. A method for facilitating the validating a call within a telecommunications network that is vendor-independent, comprising the steps of:
receiving a validation request in a first format from a telecommunications device handling said call within said telecommunications network;
determining a validating authority related to said validation request;
converting said validation request from said first format to an acceptable format related to said validating authority;
sending said converted validation request in said second format to said validating authority;
receiving a response from said validating authority based on said validation request;
converting said response to said first format; and
messaging said telecommunications device said converted response to validate said call.

19. A method for facilitating the validating a call within a telecommunications network that is vendor-independent, comprising the steps of:
receiving a validation request in a first format from a requesting party relating to billing said call via an electronic data network;
determining a validating authority related to said validation request;
converting said validation request from said first format to an acceptable format related to said validating authority;
sending said converted validation request in said second format to said validating authority;
receiving a response from said validating authority based on said validation request;
converting said response to said first format; and
messaging said requesting party said response in said first format via said electronic data network.

20. The method according to claim 19 further comprising the step of messaging said telecommunications device said converted response to validate said call.

21. The method according to claim 19, wherein said electronic data network is the Internet and World Wide Web.
